(19) United States
(12) Patent Application Publication
(10) Pub. No.: US 2020/0245050 A1
(43) Pub. Date: Jul. 30, 2020

(54) Earbud with External Driver Mount

(71) Applicant: ZAGG Intellectual Property Holding Co., Inc., Midvale, UT (US)

(72) Inventors: David Baum, Midvale, UT (US); Sean Peterson, Midvale, UT (US)

(21) Appl. No.: 16/257,519

(22) Filed: Jan. 25, 2019

(51) Int. Cl. H04R 1/10; H04R 9/06

(52) U.S. Cl. CPC H04R 1/1016; H04R 9/063

(57) ABSTRACT

An earbud comprises a housing a duct and a driver carried by the duct. A press-fit connection is formed between the driver and the duct. The driver comprises a plug extending through a distal end of the duct, and positioned both in and out of the duct. The plug of the driver has a smooth, continuous and straight outer surface along the length thereof. The plug has a greatest outer diameter of the entire driver.

### BACKGROUND

An earbud or in-ear headphone is a small headphone that is worn inside the outer ear. The earbud provides sound directly to a user's ear, The earbud can connect via a wire or wirelessly to signal source, such as a media player, a cellular phone, or an MPE player. A portion of the earbud can extend into or towards the ear canal. It is desirable that the earbud be both secure and comfortable in the user's ear while providing quality sound. The improvement of earbuds is an ongoing endeavor.

### BRIEF DESCRIPTION OF THE DRAWINGS

Features and advantages of the invention will be apparent from the detailed description which follows, taken in conjunction with the accompanying drawings, which together illustrate, by way of example, features of the invention; and, wherein:

FIG. 1 is a front view of an earbud in accordance with an embodiment of the invention.

FIG. 2 is a top view of the earbud of FIG. 1.

FIG. 3 is a front view of the earbud of FIG. 1, shown with an ear tip removed.

FIG. 4 is a rear view of the earbud of FIG. 1, shown with an ear tip removed.

FIG. 5 is a bottom view of the earbud of FIG. 1, shown with an ear tip removed.

FIG. 6 is a bottom perspective view of the earbud of FIG. 1, shown with an ear tip removed.

FIG. 7 is a cross-sectional bottom view of the earbud of FIG. 1, taken along line 7 of FIG. 3.

FIG. 8 is a detailed cross-sectional view of the earbud of FIG. 1, taken along line 8 of FIG. 7.

FIG. 9 is a perspective view of a driver of the earbud of FIG. 1.

FIG. 10 is a cross-sectional exploded view of the earbud of FIG. 1.

FIG. 11 is a partial, cross-sectional view of another earbud in accordance with an embodiment of the invention,

FIG. 12 is a side view of a driver of the earbud of FIG. 11.

FIG. 13 is a bottom perspective view of the driver of the earbud of FIG. 11.

The earbud shown in the drawings can be representative of one of a pair of earbuds.

Reference will now be made to the exemplary embodiments illustrated, and specific language will be used herein to describe the same. It will nevertheless be understood that no limitation of the scope of the invention is thereby intended.

### DETAILED DESCRIPTION

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result.

As used herein, “adjacent” refers to the proximity of two structures or elements. Particularly, elements that are identified as being “adjacent” may be either abutting or connected. Such elements may also be near or close to each other without necessarily contacting each other. The exact degree of proximity may in some cases depend on the specific context.

The terms “interference fit” and “friction fit” and “press-fit” are terms of art used interchangeably herein, unless otherwise specified, to refer to deliberately causing, increasing and/or using friction to deliberately resist movement and/or create a connection without the use of adhesive or mechanical fasteners. An interference fit or friction fit is different than and greater than the existence of friction. While friction may exist between any two surfaces, is often desirable to do all one can to reduce this friction. An interference fit or friction fit can be distinguished from naturally occurring friction by being actually deliberately caused and increased. An interference fit can be created by dimensioning engaging parts so that their surfaces tightly bear against one another. A friction fit can be created by surface roughness that is rougher.

The terms “mobile device” and “cell phone” are used interchangeably herein, unless otherwise specified, to refer to a portable handheld electronic device, such as a cellular or cell phone, tablet or tablet computer, phablet, game, and the like, with a display screen, and that is portable and handheld. The display screen can be a touch screen that can receive input by touch such as finger swipes, and/or can have a virtual keyboard. The mobile device can have a battery and memory and a processor with software running thereon. The mobile device can have cellular, WiFi and/or Bluetooth connectivity, and can have a wireless transmitter, receiver, or transceiver. Thus, the mobile device can provide internet browsing, game playing, movie and picture display, e-book display, etc. In addition, the mobile device can include a digital camera. Throughout the description, the term “cell phone” will be used as an example of the mobile device, and such use of the term “cell phone” includes all mobile devices or portable handheld electronic devices, unless otherwise specified.

Unless otherwise specified, the term “driver” is used herein to refer to a driver unit comprising a driver housing that contains a driver, an audio transducer, or a speaker. The term “driver” can reference both the audio transducer or speaker that produces audio, as well as the driver.

An initial overview of the inventive concepts are provided below and then specific examples are described in further detail later. This initial summary is intended to aid readers in understanding the examples more quickly, but is not intended to identify key features or essential features of the examples, nor is it intended to limit the scope of the claimed subject matter.

The invention presents an earbud or a pair of earbuds for providing audio to a user's ears. The earbuds can be carried in the outer ear and ear canal of the user's ears. The earbud can comprise a driver carried by a housing or duct of the housing. The driver can comprise a plug or an attachment portion with a substantial cylinder to provide a smaller and more comfortable fit in the user's ear or ear canal. In one aspect, the driver and/or the plug can be press-fit in the duct of the housing. In another aspect, the driver and/or the plug can have a smooth, continuous arid straight outer surface to provide a comfortable fit. An ear tip that is compressible can be carried by and can circumscribe the driver and the duct.

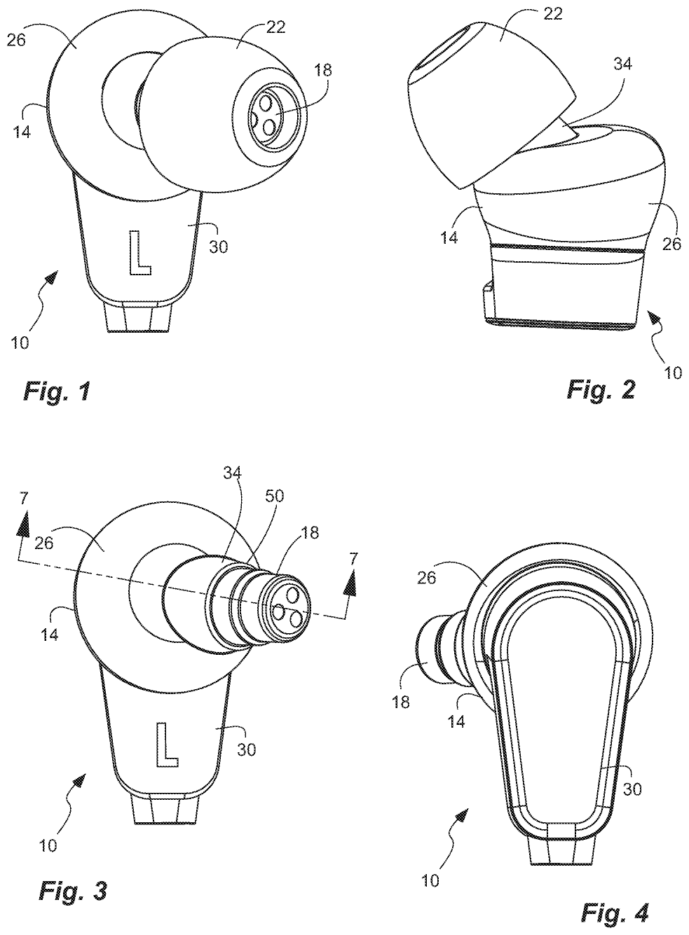

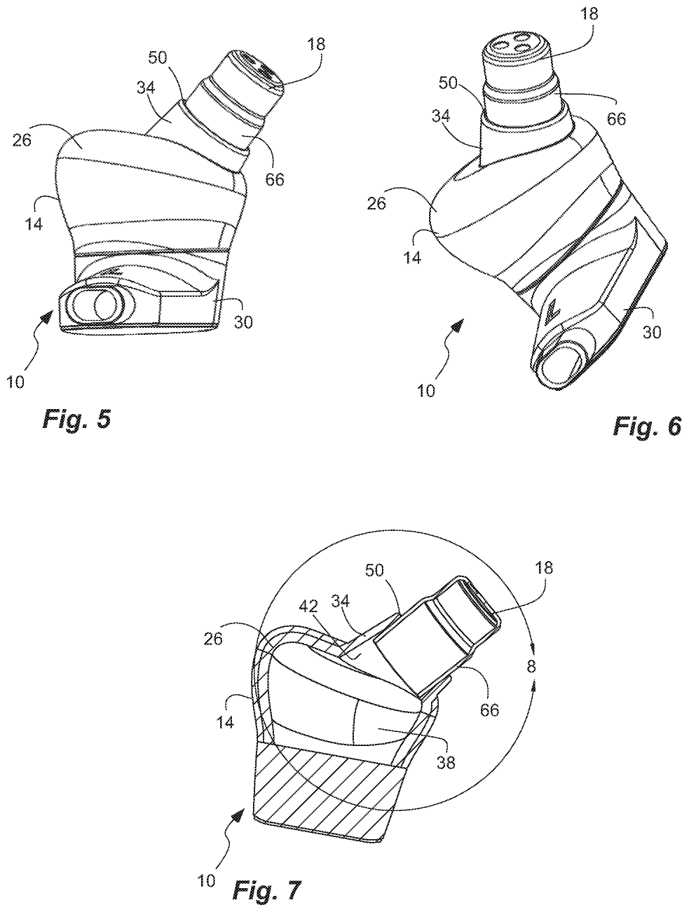

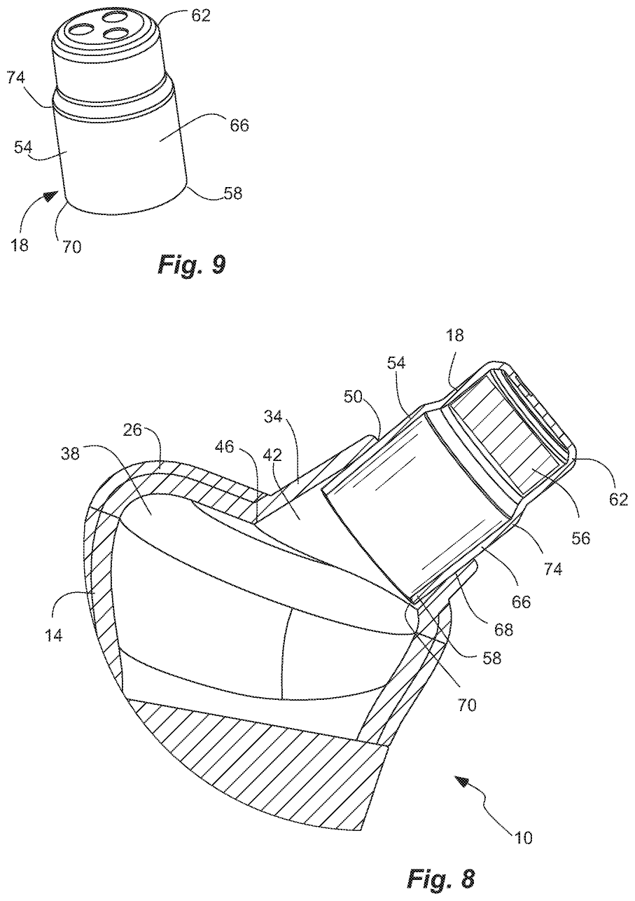

Referring to FIGS. 1-9, an earbud 10 is shown in an exemplary embodiment of the present invention for use with an audio source or signal source to provide audio to a user's ear(s). A single representative earbud is shown and described with the understanding that a pair of earbuds may be provided with one for each of a user's ears. The earbud 10 can comprise a housing 14, a driver 18 carried by the housing 14, and an ear tip 22 carried by the housing 18 and circumscribing the driver 18. The housing 14 can be sized arid shaped to be carried in the outer ear or concha of a user's ear, and to position and orient the driver 18 into the ear canal of the user's ear. The driver 18 can be positioned wholly or partially in the user's ear canal. The ear tip 22 can be flexible and resilient, or elastic, and/or compressible to be inserted into and radially fill the user's ear canal. The ear tip 22 can help hold the earbud 10 in the user's hear, and can block out unwanted ambient noise.

The housing 14 can have a main housing portion or concha portion 26, a lobe 30, and a duct 34. In one aspect, the concha portion 26, the lobe 30 and the duct 34 can be integrally formed together as a single unit, and can define the housing 18. In another aspect, the concha portion 26, the lobe 30 and the duct 34 can be separately formed, or formed as housing halves, that are joined together to form the housing 18. The housing 18 can have a hollow 38 extending wholly or partially through the concha portion 26, the lobe 30 and the duct 34. The hollow 38 can contain components of the earbud 10, such as control electronics, a battery, a Bluetooth receiver or transceiver, wire connections, etc. In addition, the hollow 38 can provide acoustic effects. The concha portion 26 can be sized and shaped to be received in the concha of the user's ear. The lobe 30 can extend from the concha portion 26, and can extend along the user's ear lobe. In one aspect, a wire can extend through the lobe 30.

The duct 34 can be carried by the concha portion 26 or the housing 18, and can define a canal 42. In one aspect, the duct 34 can extend from the concha portion 26 or the housing 18. The duct 34 can be sized, shaped and oriented to extend towards the user's ear canal. The duct 34 can be a sleeve or cylinder with a substantially circular cross-sectional shape. The duct 34 can have an open proximal end 46 open to the hollow 38 of the housing 18, and a distal end 50. (The distal end 50 can be an open distal end closed by the driver 18, as discussed below.) The distal end 50 of the duct 34 can have an inner diameter D1. In one aspect, the duct 34 can have a frusto-conical shape with the proximal end 46 having a greater diameter than the distal end 50. Similarly, the canal 42 can have a smaller inner diameter D1 at the distal end 50 of the duct 34, and a greater inner diameter D2 at the proximal end 46 of the duct 34. The housing 18, and the concha portion 26, the lobe 30 and the duct 34, can be formed of or can comprise plastic, and can be formed by injection molding.

As described above, the driver 18 is carried by the duct 34. The driver 18 can close the open distal end 50 of the duct 34. As described above, unless otherwise specified, the term “driver” is used to refer to the drive unit, which can comprise a driver housing 54 with a driver, an audio transducer 56, or a speaker therein. The driver 18 has a proximal end or portion 58 and a distal end or portion 62. The proximal end 58 of the driver 18 is positioned within the duct 34, while the distal end 62 of the driver 18 is positioned outside of the duct 34.

The driver 18 can have an attachment portion, such as a plug 66, received in the distal end 50 of the duct 34. The plug 66 can be positioned both in and out of the duct 34, or the distal end 50 thereof. The plug 66 can have an inner proximal end 70 and an outer distal end 74. The plug 66 or the attachment portion of the driver housing 54, can be a sleeve, a jacket, a sheath, a casing, or a substantial cylinder with a smooth, continuous and straight outer surface along the length thereof. In addition, the plug 66 can have a substantially circular cross-sectional shape that matches the substantially circular cross-sectional shape of the distal end 50 of the duct 34, such as the canal 42 thereof. The plug 66 has an outer diameter. In one aspect, the plug 66 can be the largest portion of the driver 18, and can have a greatest outer diameter of the entire driver 18, including the distal end 62 of the driver 18. The distal portion 62 of the driver 18 can have an outer diameter less than the greatest outer diameter of the plug 66. Thus, the driver 18 can fit comfortably in the user's ear canal. The driver 18 and the plug 66 can narrow or reduce diameter from the distal end 50 of the duct 34 to assist with user comfort.

The driver 18 and the plug 66 can have a press-fit connection 68 with and between the duct 34 or the distal end 50 thereof. In one aspect, the plug 66, and namely a portion thereof, can have an outer diameter P2 equal to or greater than the inner diameter D1 of the duct 34 or the distal end 50 thereof (P2≥D1), thus forming the press-fit connection 68. In another aspect, the plug 66 can have an outer diameter P2 greater than the inner diameter D1 of the duct 34 (P2>D1). The plug 66 can comprise a substantial cylinder with an outer diameter P1 and P2 that is substantially constant within 3% from one end to an opposite end. The plug 66 can have a change in diameter P1 and P2 between 1-3% from one end to an opposite end thereof (e.g. P2>P1). The plug 66 can have a taper from a greater outer diameter P2 outside of the duct 34, i.e. at the distal end 74, to a smaller outer diameter P1 inside of the duct 34, i.e. at the proximal end 70 (e.g. P2>P1). In one aspect, the taper can be between 0.5-3 degrees. In another aspect, the taper can be between 0.75-1.25 degrees. Thus, the proximal end 70 of the plug 66 with the smaller outer diameter P1 can be inserted into the distal end 50 of the duct 34 with a greater outer diameter D1, while an intermediate portion of the plug 66 binds in the distal end 50 of the duct 34 to form the press-fit connection 68 with a greater or equal diameter P2.

The driver 18, the driver housing 54, and/or the plug 66 can be formed of or can comprise metal, and can thus be less compliant. The duct 34, however, can be formed of plastic, and can be more compliant to receive the plug 66 and form the press-fit connection. The plug 66 can force a taper in the distal end 50 of the duct 34 to become cylindrical and create a greater surface area for the press-fit connection 68.

As described above, the ear tip 22 can be carried by the driver 18, and can circumscribe the distal end 62 of the driver 18. The ear tip 22 can be sized and shaped to fit in the user's ear canal. In addition, the tip 22 can be compressible to form a snug but comfortable fit in the user's ear canal. The ear tip 22 can be removably coupled to the driver 18.

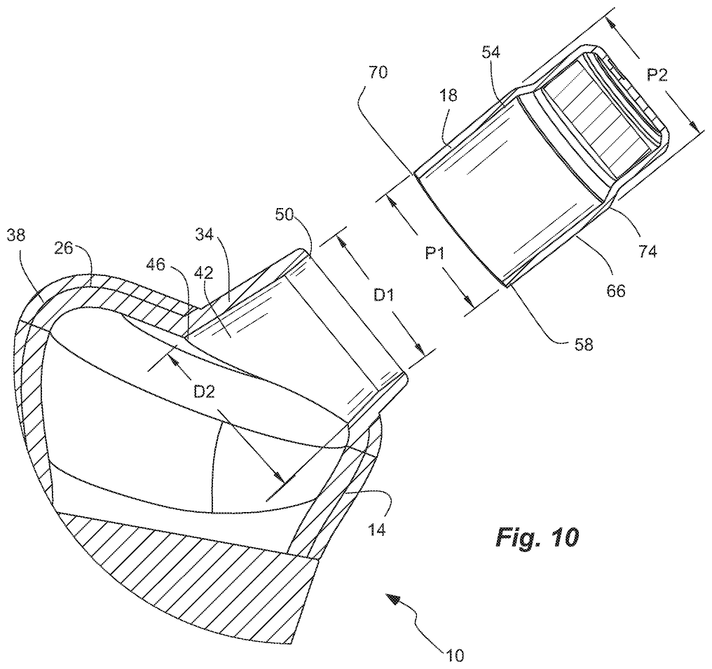

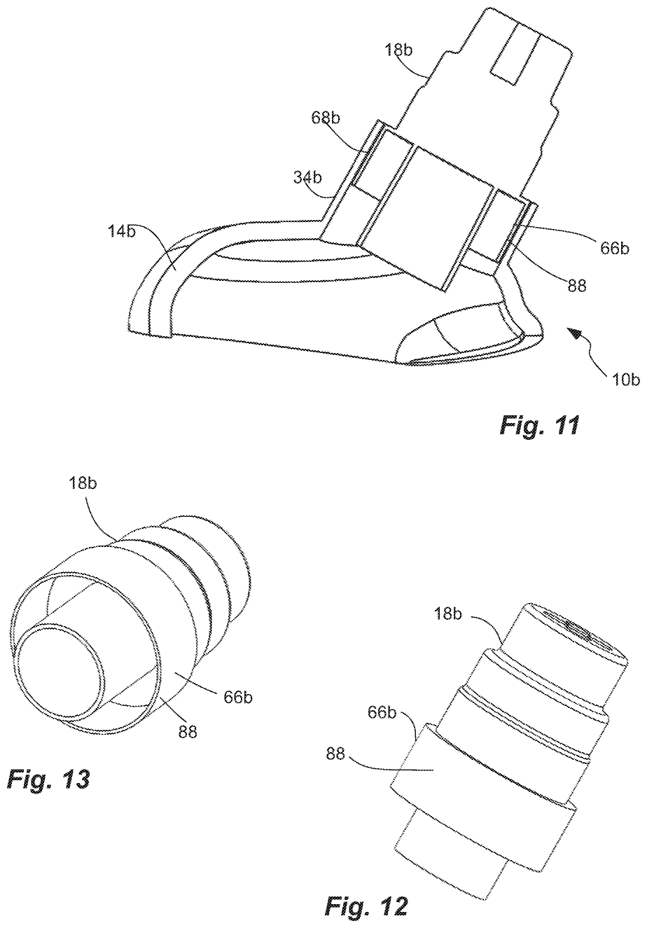

Referring to FIGS. 10-12, another earbud 10b is shown in another exemplary embodiment which is similar in many respect to that described above, and which description is incorporated herein by reference. The driver 18b can have a plug 66b with a sleeve 88 that is closed where attached to the driver, and open towards the housing 14b. The sleeve 88 can be compressible closer to the open end of the sleeve to provide a press-fit 68b. In addition, the duct 34b can be cylindrical.

It is to be understood that the examples set forth herein are not limited to the particular structures, process steps, or materials disclosed, but are extended to equivalents thereof as would be recognized by those ordinarily skilled in the relevant arts. It should also be understood that terminology employed herein is used for the purpose of describing particular examples only and is not intended to be limiting.

Furthermore, the described features, structures, or characteristics may be combined in any suitable manner in one or more examples. In the description, numerous specific details are provided, such as examples of lengths, widths, shapes, etc., to provide a thorough understanding of the technology being described. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the foregoing examples are illustrative of the principles of the invention in one or more particular applications, it will be apparent to those of ordinary skill in the art that numerous modifications in form, usage and details of implementation can be made without the exercise of inventive faculty, and without departing from the principles and concepts described herein. Accordingly, it is not intended that the invention be limited, except as by the claims set forth below.

What is claimed is:

1. An earbud comprising:
a housing having a hollow;
a duct carried by the housing and defining a canal, the duct having an open proximal end open to the hollow of the housing and a distal end;
a driver carried by the duct and closing the distal end of the duct; and
a press-fit connection between the driver and the duct.

2. The earbud of claim 1, further comprising:
the duct having an inner diameter; and
the driver having a plug received in the distal end of the duct having an outer diameter greater than the inner diameter of the duct, forming the press-fit connection

3. The earbud of claim 1, further comprising:
the driver having a plug both in and out of the duct with a smooth, continuous and straight surface along the length thereof.

4. The earbud of claim 1, further comprising:
the driver having plug received in the distal end of the duct, the plug being formed of metal and being less compliant; and
the duct being formed of plastic and being more compliant to receive the plug.

5. The earbud of claim 1, further comprising:
the driver having a plug extending through the distal end of the duct;
the plug comprising a substantial cylinder with an outer diameter that is substantially constant within 3% from one end to an opposite end; and
the plug having the greatest outer diameter of the entire driver with a distal portion of the driver having an outer diameter less than the outer diameter of the plug.

6. The earbud of claim 1, further comprising:
the duct having a frusto-conical shape with the proximal end having a greater diameter than the distal end; and
the canal having a smaller inner diameter at the distal end of the duct and a greater inner diameter at the proximal end of the duct.

7. The earbud of claim 1, further comprising:
the driver comprising a plug received in the distal end of the duct; and
the plug having a taper from a greater outer diameter outside of the duct to a smaller outer diameter inside of the duct.

8. The earbud of claim 7, further comprising:
the taper being between 0.5-3 degrees,

9. The earbud of claim 7, further comprising:
the taper being between 0.75-1.25 degrees.

10. The earbud of claim 7, further comprising:
the plug being positioned both in and out of the duct with a smooth, continuous and straight surface along the length thereof.

11. The earbud of claim 7, further comprising:
the plug having a change in diameter between 1-3% from one end to an opposite end thereof.

12. The earbud of claim 1, further comprising:
an ear tip carried by the driver and circumscribing a distal end of the driver.

13. An earbud comprising:
a housing having a hollow;
a duct carried by the housing and defining a canal, the duct having an open proximal end open to the hollow of the housing and a distal end;
a driver carried by the duct and closing the distal end of the duct;
the driver comprising a plug extending through the distal end of the duct and positioned both in and out of the duct;
the plug of the driver having a smooth, continuous and straight outer surface along the length thereof; and
the plug having a greatest outer diameter of the entire driver.

14. The earbud of claim 13, further comprising:
the plug comprising a substantial cylinder with an outer diameter that is substantially constant within 3% from one end to an opposite end,

15. The earbud of claim 13, further comprising:
the plug having a change in diameter between 1-3% from one end to an opposite end thereof.

16. The earbud of claim 13, further comprising:
the plug having a taper from a greater outer diameter outside of the duct to a smaller outer diameter inside of the duct.

17. The earbud of claim 13, further comprising:
a press-fit connection between the driver and the duct.

18. The earbud of claim 13, further comprising:
the duct having an inner diameter; and
the plug having an outer diameter equal to or greater than the inner diameter of the duct, forming a press-fit connection.

19. An earbud comprising:
a housing having a hollow and a concha portion being sized and shaped to be received in the concha of a user's ear;
a lobe extending from the concha portion configured to extend along the user's ear lobe;
a duct carried by the concha portion and defining a canal, the duct having an open proximal end open to the hollow of the housing and a distal end, the distal end of the duct having an inner diameter, the duct being sized, shaped and oriented to extend towards the user's ear canal;
a driver carried by the duct and closing the distal end of the duct;
a press-fit connection between the driver and the duct;
the driver comprising a plug extending through the distal end of the duct;
the plug positioned both in and out of the duct with a smooth, continuous and straight surface along the length thereof;
the plug comprising a substantial cylinder having a taper from a greater outer diameter outside of the duct to a smaller outer diameter inside of the duct;
the plug having an outer diameter at the distal end of the duct that is equal to or greater than the inner diameter of the distal end of the duct, forming the press-fit connection;
the plug having the greatest outer diameter of the entire driver with a distal portion of the driver having an outer diameter less than the greatest outer diameter of the plug; and
an ear tip carried by the driver and circumscribing a distal end of the driver.
